(19) United States
(12) Patent Application Publication
(10) Pub. No.: US 2026/0111478 A1
(43) Pub. Date: Apr. 23, 2026

(54) METHODS AND SYSTEMS FOR AN INTELLIGENT CONTENT FILER IN A CLOUD-BASED COLLABORATION ENVIRONMENT

(71) Applicant: Box, Inc., Redwood City, CA (US)

(72) Inventors: Kevin Day, Shelburne Falls, MA (US); Mark Lane, Greenbrae, CA (US); Alan Monier, Chicago, IL (US)

(21) Appl. No.: 18/918,625

(22) Filed: Oct. 17, 2024

(51) Int. Cl. G06F 16/35; G06F 16/332; H04L 67/10

(52) U.S. Cl. CPC G06F 16/355; G06F 16/3329; H04L 67/10

(57) ABSTRACT

Embodiments of the present disclosure are directed to generating content filer forms from a set of documents uploaded to a cloud-based collaboration environment. Generating content filer forms from a set of documents can comprise uploading the set of documents, pre-processing the uploaded documents to determine one or more document types in the set of documents and an intent for each determined document type, generating a natural language prompt for each document type based on the intent for each document type and one or more reference documents defining constraints on the natural language prompt, generating, from each natural language prompt a content filer form associated with each document type using a generative Artificial Intelligence (AI), and refining each generated content filer form.

### FIELD OF THE DISCLOSURE

Embodiments of the present disclosure relate generally to methods and systems for managing content in a cloud-based collaboration environment and more particularly to generating content filer forms from a set of documents uploaded to the cloud-based collaboration environment.

### BACKGROUND

An online or cloud-based collaboration environment is a virtual environment in which user can save, access, and modify digital content such as various types of files and folders. Typically, a user can select or define a form, i.e., a content filer form, for a type of document that can define how a document of that type should be handled when uploaded. For example, a content filer form associated with an invoice document type can contain metadata defining a folder, subfolder, etc. where the documents of that type should be stored. In existing systems providing cloud-based collaboration environments, such content filer forms are selected and/or defined manually. This is not only time-consuming but can lead to errors. Hence, there is a need in the art for improved methods and systems for generating content filer forms for a set of documents uploaded to the cloud-based collaboration environment.

### BRIEF SUMMARY

Embodiments of the present disclosure are directed to generating content filer forms for a set of documents uploaded to a cloud-based collaboration environment. According to one embodiment, a method for generating content filer forms from a set of documents in a cloud-based collaboration system can comprise uploading, from a client system to storage of the cloud-based collaboration system, a set of one or more documents, The documents can comprise documents not previously present in the storage of the cloud-based collaboration system and for which a document type has not yet been determined.

The uploaded set of one or more documents can be pre-processed to determine one or more document types in the uploaded set of one or more documents and an intent for each determined document type. Pre-processing the uploaded set of one or more documents can comprise applying a general AI analysis to the uploaded set of one or more documents, identifying the one or more document types in the uploaded set of one or more documents based on the general AI analysis, presenting, through a user interface to a user, each identified document type in the uploaded set of one or more documents along with a request for the intent for each determined document type, and receiving, through the user interface from the user, the intent for each determined document type.

A natural language prompt for each determined document type can be generated based on the intent for each determined document type and one or more reference documents defining constraints on the natural language prompt. Generating the natural language prompt for each determined document type can comprise reading the one or more reference documents defining constraints on the natural language prompt for each document type, applying a Large Language Model (LLM) Artificial Intelligence (AI) to the natural language prompt for each determined document type, the intent for each determined document type, and the one or more reference documents defining constraints on the natural language prompt for each document type to generate the natural language prompt, and presenting the generated natural language prompt to a user through a user interface. A determination can be made as to whether to modify the generated natural language prompt. In response to determining to modify the generated natural language prompt, input indicating a modification to the generated natural language prompt can be received and the generated natural language prompt can be updated based on the received input.

A content filer form associated with the document type for which the natural language prompt was generated can then be generated from each natural language prompt using a generative AI. In some cases, one or more generated content filer forms can be refined. Refining a generated content filer form can comprise presenting the generated content filer form through a user interface, receiving, through the user interface, an input indicating a user feedback related to the generated content filer form, determining, based on the received input, whether to change the generated content filer form, and in response to determining to change the generated content filer form, receiving, through the user interface, an input indicating a change to the generated content filer form, updating the generated content filer form based on the input, and training the generative AI based on the input.

In some cases, prior to generating the natural language prompt for each determined document type, a determination can be made as to whether a predefined content filer form is available for one or more of the determined document types. In response to determining a predefined content filer form is available for at least one of the determined document types, the predefined content filer form can be presented to a user through a user interface. A determination can be made as to whether to use the at least one predefined content filer form. in response to determining to use the at least one predefined content filer form the predefined content filer form can be refined. Furthermore, generating the natural language prompt for each determined document type, generating, from each natural language prompt a content filer form associated with the document type for which the natural language prompt was generated, and refining the generated content filer forms can be performed in response to determining to not use any of the at least one predefined content filer form.

According to another embodiment, a system can comprise a processor and a memory coupled with and readable by the processor. The memory can store therein a set of instructions which, when executed by the processor, causes the processor to upload, from a client system to storage of a cloud-based collaboration system, a set of one or more documents. The documents can comprise documents not previously present in the storage of the cloud-based collaboration system and for which a document type has not yet been determined.

The instructions can further cause the processor to pre-process the uploaded set of one or more documents to determine one or more document types in the uploaded set of one or more documents and an intent for each determined document type. Pre-processing the uploaded set of one or more documents can comprise applying a general AI analysis to the uploaded set of one or more documents, identifying the one or more document types in the uploaded set of one or more documents based on the general AI analysis, presenting, through a user interface to a user, each identified document type in the uploaded set of one or more documents along with a request for the intent for each determined document type, and receiving, through the user interface from the user, the intent for each determined document type.

The instructions can further cause the processor to generate a natural language prompt for each determined document type based on the intent for each determined document type and one or more reference documents defining constraints on the natural language prompt. Generating the natural language prompt for each determined document type can comprise reading the one or more reference documents defining constraints on the natural language prompt for each document type, applying a Large Language Model (LLM) AI to the natural language prompt for each determined document type, the intent for each determined document type, and the one or more reference documents defining constraints on the natural language prompt for each document type to generate the natural language prompt, and presenting the generated natural language prompt to a user through a user interface. A determination can be made as to whether to modify the generated natural language prompt. In response to determining to modify the generated natural language prompt, input indicating a modification to the generated natural language prompt can be received and the generated natural language prompt can be updated based on the received input.

The instructions can further cause the processor to generate, from each natural language prompt, a content filer form associated with the document type for which the natural language prompt was generated using a generative AI. In some cases, the instructions can further cause the processor to refine one or more generated content filer forms. Refining a generated content filer form can comprise presenting the generated content filer form through a user interface, receiving, through the user interface, an input indicating a user feedback related to the generated content filer form, determining, based on the received input, whether to change the generated content filer form, and in response to determining to change the generated content filer form, receiving, through the user interface, an input indicating a change to the generated content filer form, updating the generated content filer form based on the input, and training the generative AI based on the input.

In some cases, prior to generating the natural language prompt for each determined document type, the instructions can further cause the processor to make a determination as to whether a predefined content filer form is available for one or more of the determined document types. In response to determining a predefined content filer form is available for at least one of the determined document types, the instructions can further cause the processor to present the predefined content filer form to a user through a user interface. A determination can be made as to whether to use the at least one predefined content filer form. In response to determining to use the at least one predefined content filer form the instructions can further cause the processor to refine the predefined content filer form. Furthermore, generating the natural language prompt for each determined document type, generating, from each natural language prompt a content filer form associated with the document type for which the natural language prompt was generated, and refining the generated content filer forms can be performed in response to determining to not use any of the at least one predefined content filer form.

According to yet another embodiment, a non-transitory, computer-readable medium can comprise a set of instructions stored therein which, when executed by a processor, causes the processor to upload, from a client system to storage of a cloud-based collaboration system, a set of one or more documents. The documents can comprise documents not previously present in the storage of the cloud-based collaboration system and for which a document type has not yet been determined.

The instructions can further cause the processor to pre-process the uploaded set of one or more documents to determine one or more document types in the uploaded set of one or more documents and an intent for each determined document type. Pre-processing the uploaded set of one or more documents can comprise applying a general AI analysis to the uploaded set of one or more documents, identifying the one or more document types in the uploaded set of one or more documents based on the general AI analysis, presenting, through a user interface to a user, each identified document type in the uploaded set of one or more documents along with a request for the intent for each determined document type, and receiving, through the user interface from the user, the intent for each determined document type.

The instructions can further cause the processor to generate a natural language prompt for each determined document type based on the intent for each determined document type and one or more reference documents defining constraints on the natural language prompt. Generating the natural language prompt for each determined document type can comprise reading the one or more reference documents defining constraints on the natural language prompt for each document type, applying a Large Language Model (LLM) AI to the natural language prompt for each determined document type, the intent for each determined document type, and the one or more reference documents defining constraints on the natural language prompt for each document type to generate the natural language prompt, and presenting the generated natural language prompt to a user through a user interface. A determination can be made as to whether to modify the generated natural language prompt. In response to determining to modify the generated natural language prompt, input indicating a modification to the generated natural language prompt can be received and the generated natural language prompt can be updated based on the received input.

The instructions can further cause the processor to generate, from each natural language prompt, a content filer form associated with the document type for which the natural language prompt was generated using a generative AI. In some cases, the instructions can further cause the processor to refine one or more generated content filer forms. Refining a generated content filer form can comprise presenting the generated content filer form through a user interface, receiving, through the user interface, an input indicating a user feedback related to the generated content filer form, determining, based on the received input, whether to change the generated content filer form, and in response to determining to change the generated content filer form, receiving, through the user interface, an input indicating a change to the generated content filer form, updating the generated content filer form based on the input, and training the generative AI based on the input.

In some cases, prior to generating the natural language prompt for each determined document type, the instructions can further cause the processor to make a determination as to whether a predefined content filer form is available for one or more of the determined document types. In response to determining a predefined content filer form is available for at least one of the determined document types, the instructions can further cause the processor to present the predefined content filer form to a user through a user interface. A determination can be made as to whether to use the at least one predefined content filer form. In response to determining to use the at least one predefined content filer form the instructions can further cause the processor to refine the predefined content filer form. Furthermore, generating the natural language prompt for each determined document type, generating, from each natural language prompt a content filer form associated with the document type for which the natural language prompt was generated, and refining the generated content filer forms can be performed in response to determining to not use any of the at least one predefined content filer form.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating an exemplary cloud-based collaboration environment according to one embodiment of the present disclosure.

FIG. 4 is a flowchart illustrating an exemplary process for generating content filer forms for a set of documents according to one embodiment of the present disclosure.

FIG. 5 is a flowchart illustrating additional details of an exemplary process for pre-processing of uploaded documents according to one embodiment of the present disclosure.

FIG. 6 is a flowchart illustrating additional details of an exemplary process for prompt generation according to one embodiment of the present disclosure.

FIG. 7 is a flowchart illustrating additional details of an exemplary process for refining content filer forms according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

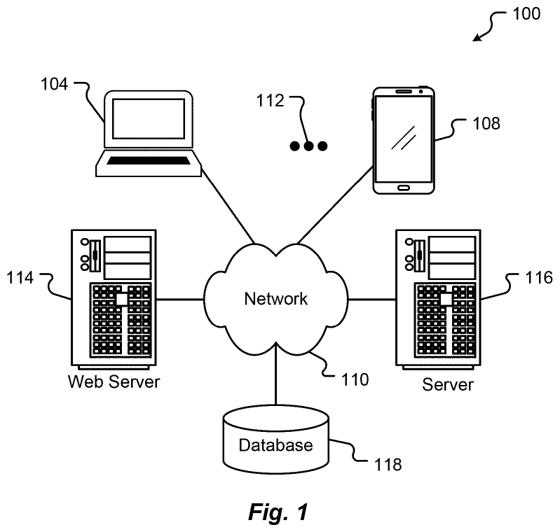

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C #®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

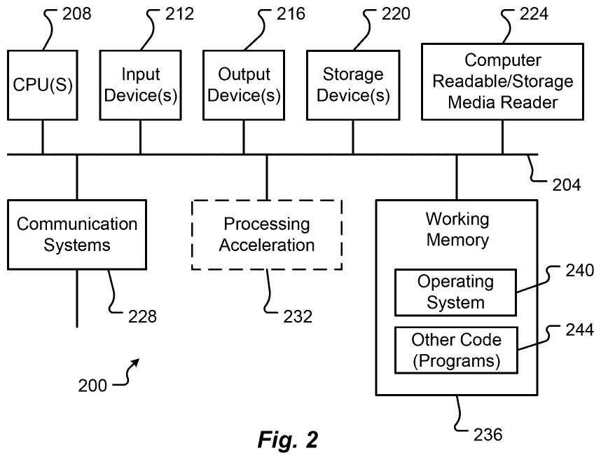

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

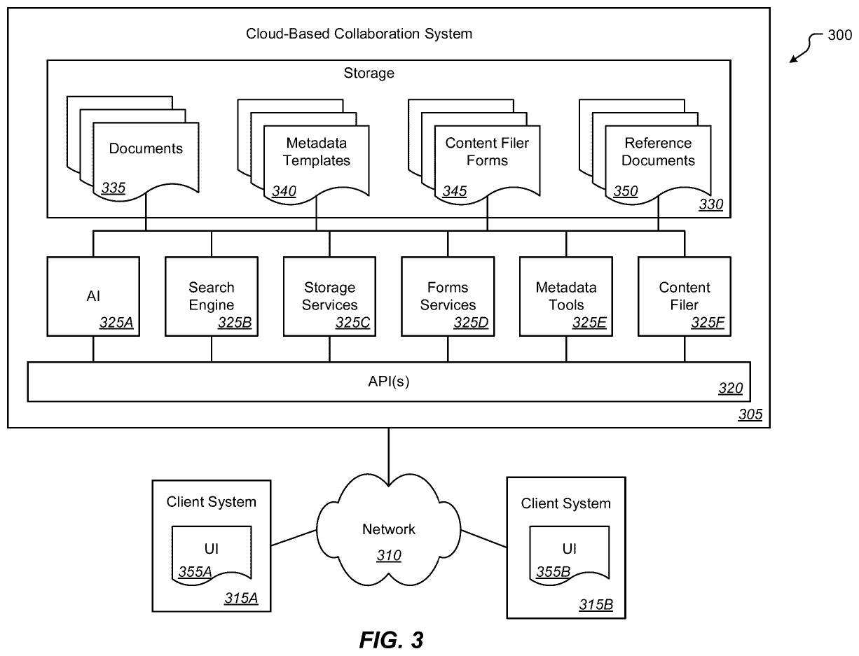

FIG. 3 is a block diagram illustrating an exemplary cloud-based collaboration environment according to one embodiment of the present disclosure. As illustrated in this example, the environment 300 can comprise a cloud-based collaboration system 305 coupled with a network 310. The cloud-based collaboration system 305 can comprise any one or more servers and/or other computing devices as described above. The network 310 can comprise any one or more wired and/or wireless, local-area and/or wide/area communications networks as described above and as known in the art including, but not limited to, the Internet. Also coupled with the network 310 can be any number of client devices 315A-315B. The client devices 315A-315B can comprise any number of laptop computers, desktop computers, tablets, smartphones, and/or other computing devices as described above and as known in the art.

Generally speaking, the cloud-based collaboration system 305 can provide online storage and access to content, for example, in a virtual workspace in which the content can be made available as one or more work items 320. Any number of online users of client devices 315A-315B can then, with proper permissions, access the work items, e.g., create, read, and edit. More specifically, the cloud-based collaboration system 305 can provide one or more Application Program Interfaces (APIs) 320 through which client applications executing one the client devices 315A-315B can access and interact with various services 325A-325G of the cloud-based collaboration system 305. These services can include, but are not limited to, Artificial Intelligence (AI) services 325A, search engine services 325B, storage services 325C, forms services 325D, metadata services 325E, and content filer services 325F.

AI services 325A can comprise various models and AI functions based thereon. For example, AI services 325A can comprise a general AI, a Large Language Model (LLM) AI, another generative AI, etc. According to one embodiment, and as will be described in greater detail below, the AI services 325A can be utilized to analyze documents uploaded to the cloud-based collaboration system 305, identify the types of documents uploaded, and perform various additional functions based on the types of document identified. For example, the AI services 325A be used to further suggest and/or generate content filer forms to associate with each type of document identified.

Search engine services 325B can comprise back-end services that index data from various sources and provides functions to search for content based on the indexes. Search engine services 320B can also provide a user interface 355A-355B through which user can search/filter/sort content stored in the cloud-based collaboration system 305.

Storage services 325C are a set of services that allow users and/or applications to store and retrieve objects as an association to an entity, e.g., enterprise, user, etc. Storage service 325C allows generation of signed URLs that can be used directly from front-end, e.g., a client application, to upload and access the image files.

Forms services 325D can be used to create and then allow users to complete forms electronically and have them populate into the cloud-based collaboration system 305. Forms services 325F can also be used to store different versions of content. The content can be, for example, any string in json format.

Metadata services 325E allows developers and services to create templates that can be attached to files, folders or content items. Then any objects of those types can have instances of those templates. The metadata services 325G can provide for querying those metadata template fields to discover objects.

Content filer services 325F can provide for automatic storage of documents uploaded to the cloud-based collaboration system 305 from client devices. To do so, the content filer services 325F can utilize a set of content filer forms 345. Each content filer form 345 can define for a particular type of document a set of metadata the content filer services 325F can use to properly store documents of that type. For example, a content filer form 345 can comprise metadata including, but not limited to, those defining metadata to be added to the document during upload, naming or renaming of the document, a location hierarchy such as folders, sub-folders, etc. in which documents are to be stored, exception handling, and/or others.

Embodiments of the present disclosure are directed to utilizing various services of the cloud-based collaboration system 305 to analyze documents uploaded to the cloud-based collaboration system 305, identify the types of documents provided, and suggest or generate content filer forms for those documents. More specifically, and as will be described in greater detail below, the storage services 325B can provide functions for uploading a set of documents 335 from a source system, e.g., a client system 315A, to the cloud-based collaboration system 305. These documents can comprise a set of unknown documents, i.e., new documents added to the cloud-based collaboration system 305 for which the documents type(s) or category/categories and/or other characteristics are yet to be determined.

Once the documents have been uploaded to the cloud-based collaboration system 305 and saved in storage 330, the documents 335 can be pre-processed by the AI services 325A. Generally speaking, pre-processing the documents can comprise applying general AI and other processes to the documents 335 to analyze the contents of the documents 335, determine what types of documents 335 have been uploaded, determine an intent for content filer forms that will be generated from the documents 335, etc.

Based on the results of pre-processing the documents 335, the AI services 325A, perhaps leveraging the search services 325B, can determine whether any predefined content filer forms 340 for the identified document type(s) are available. For example, if one or more uploaded documents are determined to be contracts, a predefined content filer form for contracts may already be defined. In such cases, the user can be given an option to use the existing content filer form, either as is or with modifications, or generate a new one.

If the user decides to generate a new content filer form, the AI services can generate one or more prompts for the document type(s) or category/categories, if more than one, found in the uploaded documents. Generally speaking, generating the prompt(s) can comprise applying a large language model generative AI to the document categories, intents, and other results of the pre-processing of the documents to generate the natural language prompt(s) describing the desired content filer form(s), and/or the metadata fields therein. Generation of the prompt(s) can also be based on a set of reference documents 350 describing, for example, best practices, standard procedures, various constraints, and/or other conditions.

Once the prompt(s) has/have been generated, the prompt(s) can be used to generate content filer form(s) 345 for each document type, if more than one. Generating the content filer forms can comprise applying a large language model and/or other generative AI to the prompt. The result can comprise a completed content filer form 345 including populated values, drop-downs, etc.

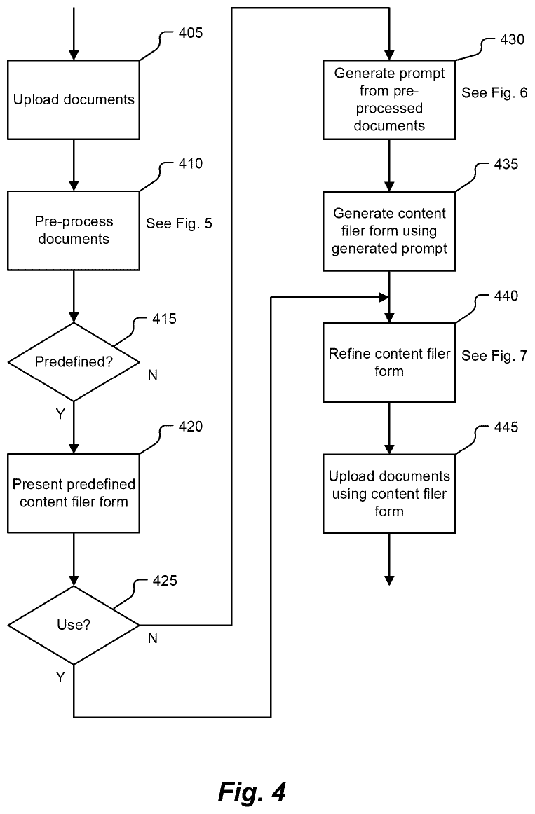

FIG. 4 is a flowchart illustrating an exemplary process for generating content filer forms from a set of documents according to one embodiment of the present disclosure. As illustrated in this example, generating content filer forms 345 from a set of documents can begin with uploading 405 a set of documents from a source system, e.g., a client system, to the cloud-based collaboration system. These documents can comprise a set of unknown documents, i.e., new documents added to the cloud-based collaboration environment for which the documents type(s) or category/categories and/or other characteristics are yet to be determined.

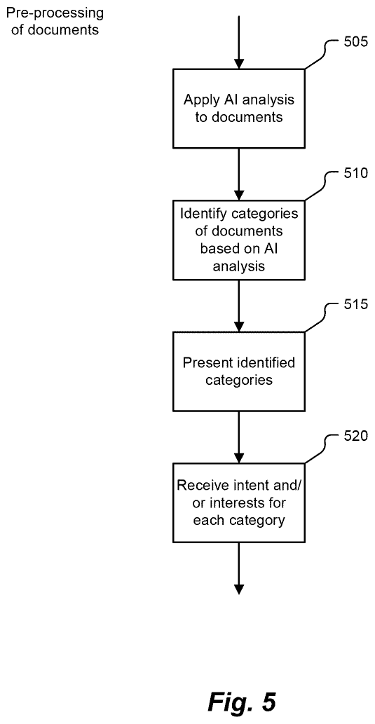

Once the documents have been uploaded 405 to the cloud-based collaboration environment and saved in storage, the documents can be pre-processed 410. Generally speaking, pre-processing 410 the documents can comprise applying AI and other processes to the documents to analyze the contents of the documents, determine what types of documents have been uploaded, determine an intent for content filer forms that will be generated from the documents, etc. Additional details of an exemplary process for pre-processing 410 of uploaded documents will be described further below with reference to FIG. 5.

Based on the results of pre-processing 410 the documents, a determination 415 can be made as to whether any predefined content filer forms for the identified document type(s) are available. In response to determining 415 a predefined content filer form 345 exists for any of the identified document type(s) the predefined content filer form for the identified document type(s) can be presented 420 to the user through a user interface 355A-355B along with a question or indication of an option to use the predefined content filer form(s) for the identified document type(s). A determination 425 can then be made as to whether the user has indicated, e.g., based on a user input through the user interface 355A-355B, an acceptance of the predefined content filer form(s). In response to determining 425 the user has accepted any of the predefined content filer form(s), the accepted content filer form(s) can then be refined 440 as will be described further below.

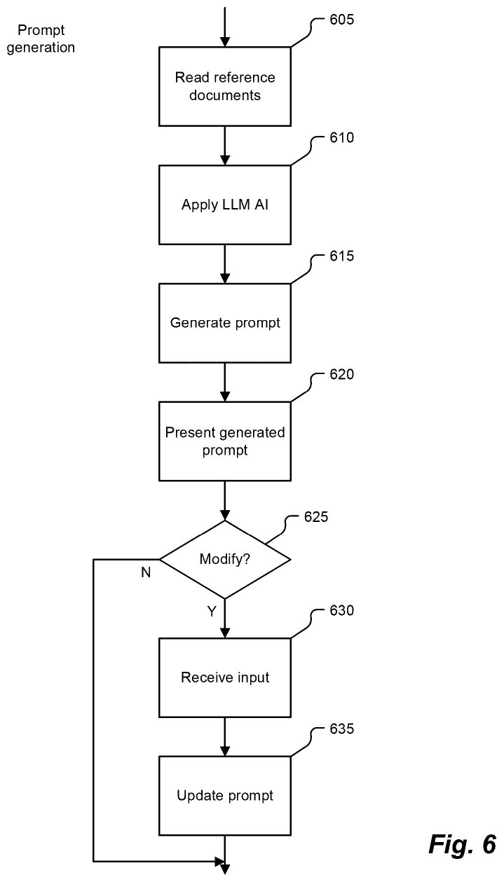

In response to determining 425 the user has not accepted a predefined content filer form for an identified document type, one or more prompts can be generated 430 for the document type(s) or type/types, if more than one. Generally speaking, generating 430 the prompt(s) can comprise applying a large language model generative AI to the document categories, intents, and other results of the pre-processing of the documents to generate the natural language prompt(s) describing the desired content filer form(s) and/or the metadata fields therein. Additional details of an exemplary process for generating 430 a prompt will be described below with reference to FIG. 6.

Once the prompt(s) has/have been generated 430, the prompt(s) can be used to generate 435 content filer form(s) for each document type, if more than one. Generating 430 the content filer forms can comprise applying a large language model and/or other generative AI to the prompt. The result can comprise a completed content filer form including populated values, drop-downs, etc.

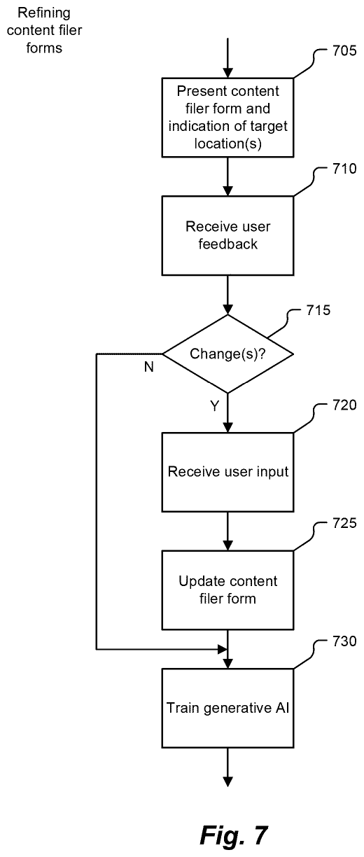

In some cases, an optional process for refining 440 a generated 435 or selected 425 pre-generated content filer form can be performed. Generally speaking, the process for refining 440 a content filer form can comprise presenting the content filer form to a user for review and acceptance, rejection, or modification of the content filer form. Additional details of an exemplary process for refining 440 a content filer form will be described below with reference to FIG. 7. Once refined 440, the content filer form 345 can be used buy the content filer service 325F to upload 445 the documents 335.

FIG. 5 is a flowchart illustrating additional details of an exemplary process for pre-processing of uploaded documents according to one embodiment of the present disclosure. As illustrated in this example, pre-processing of uploaded documents can begin with analyzing 505 the content of the documents using a large language model and/or other AI. Based on this analysis 505, one or more categories or types of documents in the set of uploaded documents can be identified 510. For example, some of the uploaded document can be found through analysis to be various contracts while others are purchase orders, accounting ledgers, engineering documents of various types, etc.

As can be expected, content filer forms for a single type of document can have a common set of metadata but will be different from another type of document. Additionally, for a given type of document, different users may have different interests in the content of the document and different intents for the content filer form. For example, one user may be interested in being able to evaluate the terms of contracts related to risk while another user may be interested in when the contracts expire.

Accordingly, the user uploading the documents can be given a chance to provide input to influence the generation of the content filer form for each identified type of documents, if more than one. More specifically, a list of the identified categories can be presented 515 to the user through a user interface 355A-355B along with one or more questions asking the user to provide an interest and/or intent for each type of documents. The user can then enter the interests and/or intent through the user interface 355A-355B in response to the presented questions. For example, an intent to store documents of a particular type in a particular file structure or to store files from users in a particular geographic location in a certain storage location can be indicated. Additionally, or alternatively, the file structure and/or storage location can be determined based on a set of rules applied to metadata of the documents, e.g., metadata identifying a business unit, document type, etc., and presented to the user for confirmation or modification. In either case, the user's input can be received 520 to be subsequently used in generation of the content filer form for each document type.

FIG. 6 is a flowchart illustrating additional details of an exemplary process for prompt generation according to one embodiment of the present disclosure. As illustrated in this example, prompt generation can begin with reading 605 a set of reference documents for each identified type of uploaded documents and can define, for example, business best practices, standard operating procedures for a business or other entity, and/or other constraints to be placed on generation of the prompt. A large language model generative AI can be applied 610 to each identified document type along with the interests, intent, and constraints from the reference documents and a prompt describing the desired content filer form can be generated 615 for each type of documents.

According to one embodiment, the generated 615 prompt can, in some cases, be presented 620 to a user, e.g., through a user interface 355A-355B, along with a an indication of an option to modify the generated prompt. A determination 625 can then be made as to whether the user has indicated, e.g., based on a user input through the user interface 355A-355B, an acceptance of the option to modify the generated prompt. In response to determining 625 the user has accepted the option to modify the generated prompt, user input of modifications of the prompt, e.g., edits to the prompt, can be received 630 and the prompt can be updated 635 based on the received edits or modifications.

FIG. 7 is a flowchart illustrating additional details of an exemplary process for refining content filer forms according to one embodiment of the present disclosure. As illustrated in this example, refining a generated or selected pre-generated content filer form can comprise presenting 705 the content filer form and an indication of the target storage location(s) based on the generated content filer form to a user through a user interface 355A-355B and receiving 710 feedback on the presented 705 content filer form from the user through the user interface 355A-355B. For example, the feedback can comprise acceptance of the content filer form as it is presented. In other cases, the feedback can comprise rejection of the content filer form in whole. In yet other cases, the feedback can comprise a request or indication to modify the content filer form.

Accordingly, a determination 715 can be made as to whether the feedback indicates a request or indication to modify the content filer form. In response to determining 715 the feedback indicates a request or indication to modify the content filer form, user input modifying the content filer form can be received 720 through the user interface 355A-355B and the content filer form can be updated 725 based on the received 720 input. For example, input received for a content filer form can include, but is not limited to, an indication of whether to maintain versioning on documents uploaded using the content filer form. The received modifications can then be used for training 730 the generative AI. Additionally, if a determination 715 is made that the received 710 feedback does not indicate a request or indication to modify the content filer form, i.e., it indicates either an acceptance of the content filer form as generated or a rejection of the content filer form in whole, this feedback can also be used to train 730 the generative AI.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for generating content filer forms from a set of documents in a cloud-based collaboration system, the method comprising:
storing, by the cloud-based collaboration system, a set of one or more documents from a client system, wherein the documents comprise documents not previously present in storage of the cloud-based collaboration system and for which a document type has not yet been determined;
pre-processing, by the cloud-based collaboration system, the uploaded set of one or more documents to determine one or more document types in the uploaded set of one or more documents and an intent for each determined document type;
generating, by the cloud-based collaboration system, a natural language prompt for each determined document type based on the intent for each determined document type and one or more reference documents defining constraints on the natural language prompt;
generating, by the cloud-based collaboration system, from each natural language prompt a content filer form associated with each document type using a generative Artificial Intelligence (AI); and
refining, by the cloud-based collaboration system, each generated content filer form.

2. The method of claim 1, further comprising:
prior to generating the natural language prompt for each determined document type, determining, by the cloud-based collaboration system, whether a predefined content filer form is available for one or more of the determined document types; and
in response to determining a predefined content filer form is available for at least one of the determined document types, presenting, by the cloud-based collaboration system, the predefined content filer form to a user through a user interface.

3. The method of claim 2, further comprising:
determining, by the cloud-based collaboration system, whether to use the at least one predefined content filer form; and
in response to determining to use the at least one predefined content filer form, refining, by the cloud-based collaboration system, the predefined content filer form, wherein generating the natural language prompt for each determined document type, generating, from each natural language prompt a content filer form associated with the document type for which the natural language prompt was generated, and refining the generated content filer forms is performed in response to determining to not use any of the at least one predefined content filer form.

4. The method of claim 1, wherein pre-processing the uploaded set of one or more documents further comprises:
applying a general AI analysis to the uploaded set of one or more documents;
identifying the one or more document types in the uploaded set of one or more documents based on the general AI analysis;
presenting, through a user interface to a user, each identified document type in the uploaded set of one or more documents along with a request for the intent for each determined document type; and
receiving, through the user interface from the user, the intent for each determined document type.

5. The method of claim 1, wherein generating the natural language prompt for each determined document type comprises:
reading the one or more reference documents defining constraints on the natural language prompt for each document type;
applying a Large Language Model (LLM) AI to the natural language prompt for each determined document type, the intent for each determined document type, and the one or more reference documents defining constraints on the natural language prompt for each document type to generate the natural language prompt; and
presenting the generated natural language prompt to a user through a user interface.

6. The method of claim 5, wherein generating the natural language prompt for each determined document type further comprises:
determining whether to modify the generated natural language prompt; and
in response to determining to modify the generated natural language prompt, receiving input indicating a modification to the generated natural language prompt and updating the generated natural language prompt based on the received input.

7. The method of claim 1, wherein refining each generated content filer form comprises:
presenting the generated content filer form through a user interface;
receiving, through the user interface, an input indicating a user feedback related to the generated content filer form;
determining, based on the received input, whether to change the generated content filer form; and
in response to determining to change the generated content filer form, receiving, through the user interface, an input indicating a change to the generated content filer form, updating the generated content filer form based on the input, and training the generative AI based on the input.

8. A system comprising:
a processor; and
a memory coupled with and readable by the processor and storing therein a set of instructions which, when executed by the processor, causes the processor to:
store a set of one or more documents from a client system to storage of a cloud-based collaboration environment, wherein the documents comprise documents not previously present in the storage of the cloud-based collaboration system and for which a document type has not yet been determined;
pre-process the uploaded set of one or more documents to determine one or more document types in the uploaded set of one or more documents and an intent for each determined document type;
generate a natural language prompt for each determined document type based on the intent for each determined document type and one or more reference documents defining constraints on the natural language prompt;
generate, from each natural language prompt, a content filer form associated with each document type using a generative Artificial Intelligence (AI); and
refine each generated content filer form.

9. The system of claim 8, further comprising:
prior to generating the natural language prompt for each determined document type, determining, by the cloud-based collaboration system, whether a predefined content filer form is available for one or more of the determined document types; and
in response to determining a predefined content filer form is available for at least one of the determined document types, presenting, by the cloud-based collaboration system, the predefined content filer form to a user through a user interface.

10. The system of claim 9, further comprising:
determining, by the cloud-based collaboration system, whether to use the at least one predefined content filer form; and
in response to determining to use the at least one predefined content filer form, refining, by the cloud-based collaboration system, the predefined content filer form, wherein generating the natural language prompt for each determined document type, generating, from each natural language prompt a content filer form associated with the document type for which the natural language prompt was generated, and refining the generated content filer forms is performed in response to determining to not use any of the at least one predefined content filer form.

11. The system of claim 8, wherein pre-processing the uploaded set of one or more documents further comprises:
applying a general AI analysis to the uploaded set of one or more documents;
identifying the one or more document types in the uploaded set of one or more documents based on the general AI analysis;
presenting, through a user interface to a user, each identified document type in the uploaded set of one or more documents along with a request for the intent for each determined document type; and
receiving, through the user interface from the user, the intent for each determined document type.

12. The system of claim 8, wherein generating the natural language prompt for each determined document type comprises:
reading the one or more reference documents defining constraints on the natural language prompt for each document type;
applying a Large Language Model (LLM) AI to the natural language prompt for each determined document type, the intent for each determined document type, and the one or more reference documents defining constraints on the natural language prompt for each document type to generate the natural language prompt; and
presenting the generated natural language prompt to a user through a user interface.

13. The system of claim 12, wherein generating the natural language prompt for each determined document type further comprises:
determining whether to modify the generated natural language prompt; and
in response to determining to modify the generated natural language prompt, receiving input indicating a modification to the generated natural language prompt and updating the generated natural language prompt based on the received input.

14. The system of claim 8, wherein refining each generated content filer form comprises:
presenting the generated content filer form through a user interface;
receiving, through the user interface, an input indicating a user feedback related to the generated content filer form;
determining, based on the received input, whether to change the generated content filer form; and
in response to determining to change the generated content filer form, receiving, through the user interface, an input indicating a change to the generated content filer form, updating the generated content filer form based on the input, and training the generative AI based on the input.

15. A non-transitory, computer-readable medium comprising a set of instructions stored therein which, when executed by a processor, causes the processor to:
store a set of one or more documents from a client system to storage of a cloud-based collaboration environment, wherein the documents comprise documents not previously present in the storage of the cloud-based collaboration system and for which a document type has not yet been determined;
pre-process the uploaded set of one or more documents to determine one or more document types in the uploaded set of one or more documents and an intent for each determined document type;
generate a natural language prompt for each determined document type based on the intent for each determined document type and one or more reference documents defining constraints on the natural language prompt;
generate, from each natural language prompt, a content filer form associated with each document type using a generative Artificial Intelligence (AI); and
refine each generated content filer form.

16. The non-transitory, computer-readable of claim 15, further comprising:
prior to generating the natural language prompt for each determined document type, determining, by the cloud-based collaboration system, whether a predefined content filer form is available for one or more of the determined document types; and
in response to determining a predefined content filer form is available for at least one of the determined document types, presenting, by the cloud-based collaboration system, the predefined content filer form to a user through a user interface.

17. The non-transitory, computer-readable of claim 16, further comprising:
determining, by the cloud-based collaboration system, whether to use the at least one predefined content filer form; and
in response to determining to use the at least one predefined content filer form, refining, by the cloud-based collaboration system, the predefined content filer form, wherein generating the natural language prompt for each determined document type, generating, from each natural language prompt a content filer form associated with the document type for which the natural language prompt was generated, and refining the generated content filer forms is performed in response to determining to not use any of the at least one predefined content filer form.

18. The non-transitory, computer-readable of claim 15, wherein pre-processing the uploaded set of one or more documents further comprises:
applying a general AI analysis to the uploaded set of one or more documents;
identifying the one or more document types in the uploaded set of one or more documents based on the general AI analysis;
presenting, through a user interface to a user, each identified document type in the uploaded set of one or more documents along with a request for the intent for each determined document type; and
receiving, through the user interface from the user, the intent for each determined document type.

19. The non-transitory, computer-readable of claim 15, wherein generating the natural language prompt for each determined document type comprises:
reading the one or more reference documents defining constraints on the natural language prompt for each document type;
applying a Large Language Model (LLM) AI to the natural language prompt for each determined document type, the intent for each determined document type, and the one or more reference documents defining constraints on the natural language prompt for each document type to generate the natural language prompt; and
presenting the generated natural language prompt to a user through a user interface;
determining whether to modify the generated natural language prompt; and
in response to determining to modify the generated natural language prompt, receiving input indicating a modification to the generated natural language prompt and updating the generated natural language prompt based on the received input.

20. The non-transitory, computer-readable of claim 15, wherein refining each generated content filer form comprises:
presenting the generated content filer form through a user interface;
receiving, through the user interface, an input indicating a user feedback related to the generated content filer form;
determining, based on the received input, whether to change the generated content filer form; and
in response to determining to change the generated content filer form, receiving, through the user interface, an input indicating a change to the generated content filer form, updating the generated content filer form based on the input, and training the generative AI based on the input.
